(19) United States
(12) Patent Application Publication
(10) Pub. No.: US 2021/0130074 A1
(43) Pub. Date: May 6, 2021

(54) THERMAL INSULATING CONTAINER WITH A COMBINATION INNER LINER

(71) Applicant: GI DEON ENTERPRISE CO., LTD., Taichung City (TW)

(72) Inventor: Ching-Wen LIU, Taichung City (TW)

(21) Appl. No.: 16/891,700

(22) Filed: Jun. 3, 2020

(30) Foreign Application Priority Data
Oct. 31, 2019 (TW) 108214365

(51) Int. Cl. B65D 81/38; B65D 8/00; B32B 15/00; B32B 27/00; B32B 17/06; B32B 18/00

(52) U.S. Cl. CPC B65D 81/3846; B65D 81/3841; B65D 15/18; B32B 15/00; B32B 2307/304; B32B 17/061; B32B 17/064; B32B 18/00; B32B 2439/40; B32B 27/00

(57) ABSTRACT

Disclosed is a thermal insulating container with a combination inner liner, which includes a cup, surrounded with a storage space and forming an open end. The inner edge of the open end has an inner locking part. An inner liner is surrounded with a bearing space and forms an opening end, wherein the inner liner is fitted in the storage space, and the opening end is provided with a screw thread section. There is a connecting part under the screw thread section. An external member is assembled on the connecting part, and there is an outer locking part on the external surface of the external member. The outer locking part is assembled with the inner locking part of the cup body. A cover has an edge which is a circumferential wall extended downwards, and is provided with a ridge section screwed on/off the screw thread section of the inner liner.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a combination inner liner, and more particularly to an innovative type of a thermal insulating container with a combination inner liner.

### 2. Description of Related Art Including Information Disclosed Under 37 CFR 1.97 and 37 CFR 1.98.

In order to prevent potables from losing temperature, people put the potables in an insulating container body assembled of internal and external layers, with a cover body for sealing, so that the iced or warm potables can be drunk outdoors or when icing or heating the potables.

The present insulating container is assembled of a ceramic inner liner and a metallic outer casing. There are two combination methods, the first one is that the outer casing wraps the inner liner, and the space under the joint of the outer casing and the inner liner is sealed with foams, and the opening of the inner liner spans the opening of the outer casing. The second one is that the inner liner is provided with a telescoping part under the opening of the inner liner, when the inner liner is telescoped into the outer casing, it is telescoped in the opening of the outer casing through the telescoping part, and the inner liner is supported.

However, this structure type still has the following problems in practical experience. For example, the first method uses foams to seal the space under the joint of the outer casing and the inner liner, if the insulating container contains cold water or hot water, the inner liner and outer casing made of materials of different properties have inconsistent thermal expansion and contraction, so that the space under the joint expands or contracts, destroying the sealing adhesion of foams, or destroying the closure of telescoping part between inner liner and outer casing, the inner liner is likely to loosen, and the opening ofthe inner liner spans the opening of the outer casing, there is a gap between the two openings, the gap between the two openings is likely to breed bacteria and store dirt as time passes. The second method telescopes the telescoping part of the inner liner into the opening of the outer casing, so that the opening of inner liner is far from the opening of the outer casing, solving the problem in the first method that the gap between two openings is likely to breed bacteria and store dirt. However, if the insulating container contains cold water or hot water, leading to inconsistent thermal expansion and contraction of heterogeneous materials of inner liner and outer casing, the space under the joint expands or contracts, destroying the closure of the telescoping part between inner liner and outer casing, the inner liner is likely to get loose as a result, and the opening of the inner liner spans the opening of the outer casing, it is unsteady and likely to get loose.

Therefore, for the problems in said structure, how to develop an innovative structure with more ideal practicability is what the users desire, as well as the objective and direction ofresearch and development the related suppliers shall break through. In view of this, this inventor, with years' experience in manufacturing, developing and designing related products, made detailed design and careful evaluation for said objective, the present utility model with practicability was obtained eventually.

### BRIEF SUMMARY OF THE INVENTION

The primary object ofthe present utility model is to provide a thermal insulating container with a combination inner liner. The technical problem to be solved is to break through how to develop a novel structure type of a thermal insulating container with a combination inner liner with more ideal practicability.

Based on said object, the present utility model provides a thermal insulating container with a combination inner liner, which comprises a cup, surrounded with a storage space and forming an open end, and the inner edge of open end is provided with an inner locking part; an inner liner, surrounded with a bearing space and forming an opening end, wherein the inner liner is fitted in the storage space of cup body, and the opening end is provided with a screw thread section, there is a connecting part under the screw thread section; an external member, assembled on the connecting part of inner liner, and there is an outer locking part on the external surface of the external member, the outer locking part is assembled with the inner locking part of cup body; a cover, its edge is a circumferential wall extended downwards, and its section is ?-shaped, the cover is provided with a ridge section, the ridge section is screwed on/off the screw thread section of inner liner.

Based on the innovative particular type and technical characteristic, in comparison to prior art, the connecting part of the inner liner and the ring slot of the external member buckle each other, the outer locking part of the external member and the inner locking part of the cup can be assembled, so that even if there are expansion and contraction due to temperature effect between the cup and the inner liner, their relative positions will remain, achieving the practical progressiveness of greatly enhanced firmness.

Another purpose of the present utility model is to dispose a connecting part under the opening end of the inner liner, so that the annular bulge of the connecting part and the ring slot of the external member buckle each other, the gap between the inner liner and the cup is displaced under the annular bulge, the opening end of the inner liner contacts the user's mouth, it is unlikely to breed bacteria and store dirt, implementing the practical progressiveness of greatly enhanced cleanness and greatly enhanced hygienic safety. dr

### BRIEF DESCRIPTION OF THE SEVERAL VIEWS OF THE DRAWINGS

FIG. 1 is the combined stereogram of the preferred embodiment of this structure.

FIG. 2 is the exploded view of the preferred embodiment of this structure.

FIG. 3 is the combined section view of the preferred embodiment of this structure.

FIG. 4 is the close-up view of FIG. 3.

FIG. 5 is the combined section view of Embodiment 1 of the present utility model.

FIG. 6 is the close-up view of FIG. 5.

FIG. 7 is the close-up view of rotary snap-in inner locking part of the cup body.

### DETAILED DESCRIPTION OF THE INVENTION

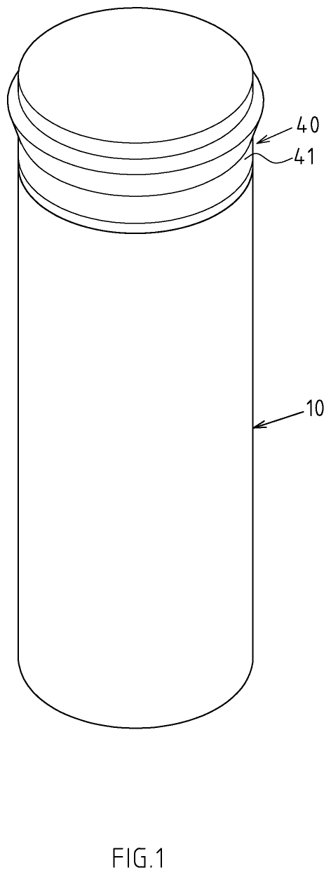

FIG. 1 to FIG. 4 show the preferred embodiments of the insulating container with a combination inner liner ofthe present invention, but the embodiments are for illustration only, the patent application is not limited to this structure.

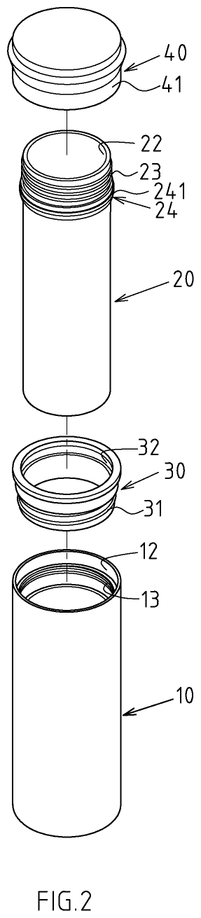

The aforementioned insulating container with a combination inner liner comprises a cup 10, surrounded with a storage space 11 and forming an open end 12, the inner edge of the open end 12 is provided with an inner locking part 13; an inner liner 20, surrounded with a bearing space 21 and forming an opening end 22, wherein the inner liner 20 is fitted in the storage space 11 of the cup 10 (bearing space 21 contains liquid), the opening end 22 is provided with a screw thread section 23, there is a connecting part 24 under the screw thread section 23; an external member 30, assembled on the connecting part 24 of the inner liner 20, and there is an outer locking part 31 on the external surface of the external member 30. The outer locking part 31 is assembled with the inner locking part 13 of the cup 10; a cover 40, its edge is a circumferential wall 41 extended downwards and its section is Π-shaped, the cover 40 is provided with a ridge section 42, the ridge section 42 is screwed on/off the screw thread section 23 of the inner liner 20; and the inner liner 20 is made of glass material or ceramic material; the cup 10 is made of plastic material or metal material.

Wherein the cup 10 is double layer pattern, the inner and outer layers of the aforementioned double layer pattern are homogeneously or heterogeneously made ofplastic and metal materials. The inner and outer layers of the cup 10 are made of plastic material or metal material, or the inner layer of the cup 10 is made of plastic material or metal material, and the outer layer is made of a material different from the inner layer.

Wherein the connecting part 24 has a bulge 241 and the external member 30 has a slot 32 fitting the bulge 241, the external member 30 is telescoped into the inner liner 20, so that the slot 32 buckles the bulge 241. The bulge 241 and slot 32 disclosed in this example can be annularly fitted (as shown in FIG. 2), or non-annularly fitted (omitted).

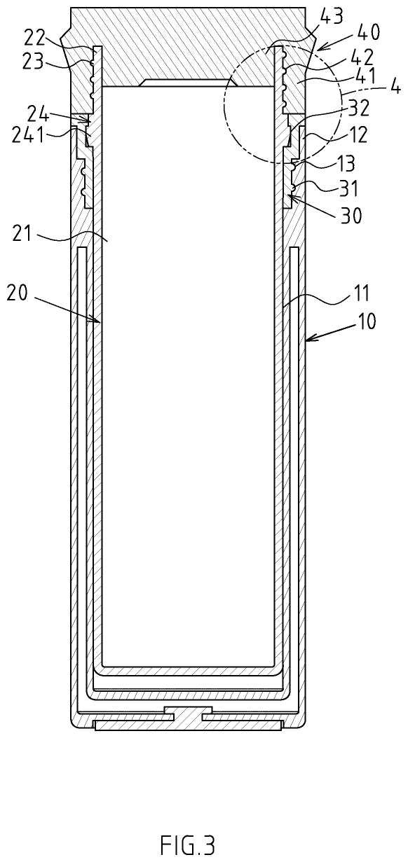

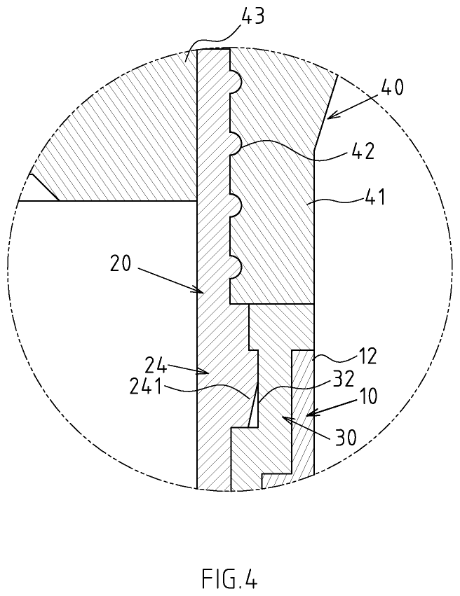

As shown in FIGS. 3 and 4, in this case, the screw thread section 23 of the opening end 22 is located on the outer margin of the opening end 22, the ridge section 42 of the cover 40 is located on the inner margin of circumferential wall 41, so that the opening end 22 and the cover 40 are assorted with each other.

As shown in FIG. 3 to FIG. 6, a lug 43 protrudes down from the center of the cover 40, when the opening end 22 coordinates with the cover 40, the lug 43 prevents liquid from flowing out.

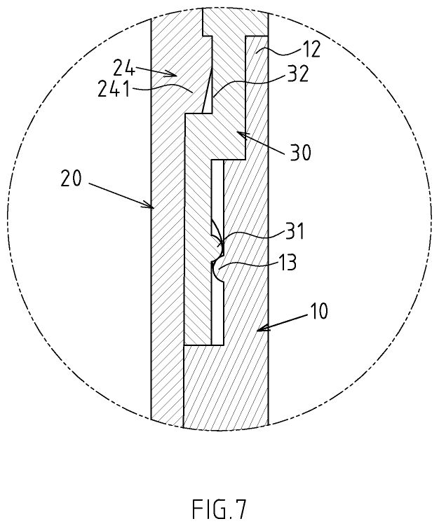

As shown in Figs.3 and 7, in this case, the inner locking part 13 of the cup 10 is threaded (as shown in FIG. 3) or rotary snap-in (as shown in FIG. 7), the outer locking part 31 of the external member 30 coordinates with the inner locking part 13.

Based on said structural composition type and technical characteristic, in practical application of the insulating container structure with a combination inner liner disclosed in the present utility model, the external member 30 is buckled on the inner liner 20, and then the inner liner 20 is assembled on the cup 10, the cover 40 is screwed on the opening end 22 of the inner liner 20 at last. The cup 10 is double layer pattern (heat insulation and cold insulation), the connecting part 24 of the inner liner 20 and the ring slot 32 of the external member 30 buckle each other, the outer locking part 31 of the external member 30 and the inner locking part 13 of the cup 10 are assembled, so that even if there are expansion and contraction due to temperature effect between the cup 10 and the inner liner 20, their relative positions will remain, the firmness is enhanced greatly. There is a connecting part 24 under the opening end 22 of the inner liner 20, so that the annular bulge 241 of the connecting part 24 and the ring slot 32 of the external member 30 buckle each other, the gap between the inner liner 20 and the cup 10 is displaced under the annular bulge 241, the opening end 22 of the inner liner 20 contacts the user's mouth, it is unlikely to breed bacteria and store dirt, the cleanness and hygienic safety are enhanced greatly.

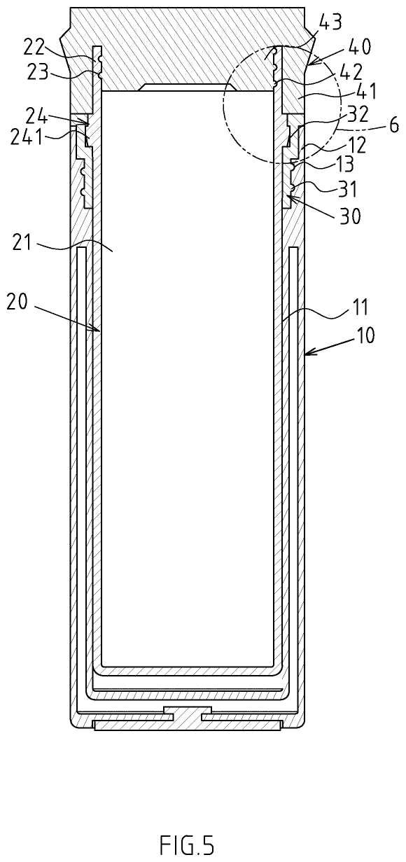

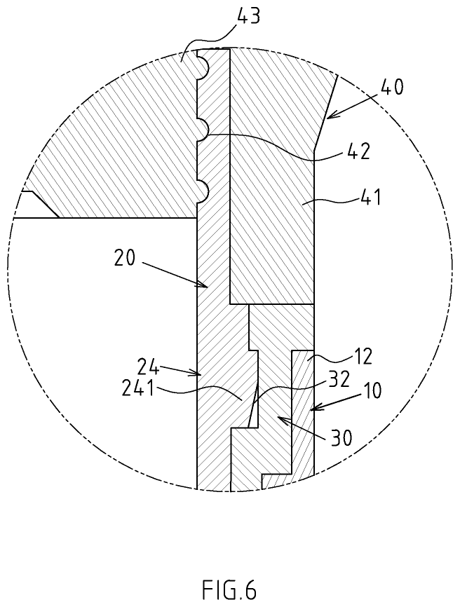

FIGS. 5 and 6 disclose the first embodiment of the present utility model, the screw thread section 23 of the opening end 22 is located on the inner margin of the opening end 22, the ridge section 42 of the cover 40 is located on the outer edge of lug 43 of the cover 40, the outer margin of the lug 43 does not contact the inner margin of circumferential wall 41 of the cover 40, so that the opening end 22 and the cover 40 are assorted with each other.

I claim:

1. A thermal insulating container with a combination inner liner, comprising:
a cup, surrounded with a storage space and forming an open end, the inner edge of the open end is provided with an inner locking part;
an inner liner, surrounded with a bearing space and forming an opening end, wherein the inner liner is fitted in the storage space of the cup, and the opening end is provided with a screw thread section, there is a connecting part under the screw thread section;
an external member, assembled on the connecting part of the inner liner, there is an outer locking part on the external surface of the external member, the outer locking part is assembled on the inner locking part of the cup;
a cover, its edge is a circumferential wall extended downwards, and its section is Π-shaped; the cover is provided with a ridge section, the ridge section is screwed on/off the screw thread section of the inner liner.

2. The thermal insulating container with a combination inner liner defined in claim 1, wherein the inner locking part of the cup is threaded or rotary snap-in, the outer locking part of the external member coordinates with the inner locking part.

3. The thermal insulating container with a combination inner liner defined in claim 1, wherein the screw thread section of the opening end is located on the outer margin of the opening end, and the ridge section of the cover is located on the inner margin of circumferential wall of the cover, so that the opening end and the cover are assorted with each other.

4. The thermal insulating container with a combination inner liner defined in claim 3, wherein the inner liner and the cup are glass or ceramic; and the cup is double layer pattern; the inner and outer layers of the aforementioned double layer pattern are homogeneously or heterogeneously made of plastic and metal materials.

5. The thermal insulating container with a combination inner liner defined in claim 4, wherein the connecting part has a bulge, the external member has a slot matching the bulge, so that when the external member is telescoped into the inner liner, the slot buckles the bulge.

6. The thermal insulating container with a combination inner liner defined in claim 2, wherein the screw thread section of the opening end is located on the outer margin of the opening end, and the ridge section of the cover is located on the inner margin of circumferential wall of the cover, so that the opening end and the cover are assorted with each other.

7. The thermal insulating container with a combination inner liner defined in claim 6, wherein the inner liner and the cup are glass or ceramic; and the cup is double layer pattern; the inner and outer layers of the aforementioned double layer pattern are homogeneously or heterogeneously made of plastic and metal materials.

8. The thermal insulating container with a combination inner liner defined in claim 7, wherein the connecting part has a bulge, the external member has a slot matching the bulge, so that when the external member is telescoped into the inner liner, the slot buckles the bulge.
